(19) United States
(12) Patent Application Publication
(10) Pub. No.: US 2006/0287895 A1
(43) Pub. Date: Dec. 21, 2006

(54) Negative equity insurance

(75) Inventor: Marcos Salas, Wilmington, NC (US)

Correspondence Address: WILLIAM J. MASON;MACCORD MASON PLLC, POST OFFICE BOX 1489, WRIGHTSVILLE BEACH, NC, 28480, US

(73) Assignee: National Autos LLC dba Autoland of Wilmington

(21) Appl. No.: 11/157,359

(22) Filed: Jun. 21, 2005

(51) Int. Cl. G06Q 40/00

(52) U.S. Cl. 705/4

(57) ABSTRACT

A method is provided to compensate a vehicle buyer for negative equity in a vehicle purchased from a vehicle dealer and traded at a predetermined time after purchase of the vehicle. At the time the vehicle is purchased from a participating vehicle dealer, an insurer issues a premium bearing policy to the vehicle purchaser. If the purchaser pays the required premiums over the predetermined time, the insurer will pay on behalf of the buyer a compensated value equal to the amount owed on the vehicle less deductions and less the unadjusted fair market value of the vehicle at the time the vehicle is traded with a participating vehicle dealer, which may be the same or different from the vehicle dealer from whom the vehicle was originally purchased, depending on the terms of the policy.

### BACKGROUND OF THE INVENTION

(1) Field of the Invention

The present invention relates to a method for compensating policyholders for the difference between the amount owed on a vehicle and the unadjusted fair market value of a vehicle at the time the vehicle is traded with a participating vehicle dealer.

(2) Description of the Prior Art

A newly purchased vehicle immediately depreciates by up to twenty percent in value when it is driven from the dealer's lot. That is, the value of the “used” vehicle is less than the value of the “new” vehicle. This fact combined with the practice of many purchasers to finance vehicles with little or no down payment for up to 72 months results in the amount owed on the vehicle being substantially more than the vehicle is worth for a considerable period of time after purchase. This difference in value, known as negative equity or being “upside down”, continues until the purchaser has made sufficient payments to reduce the outstanding amount of the loan to an amount that is less than the fair market value of the vehicle.

However, many vehicle owners desire to trade their vehicle while the value of the vehicle is still less than the amount of the outstanding loan. Then, the owner finds at the time of trading that the vehicle, instead of serving as a down payment on a new vehicle, in fact necessitates the payment of an amount in addition to the cost of the new vehicle to cover the negative equity in the old vehicle. In many instances, the owner is able to finance this additional amount along with the price of the new vehicle, increasing his payments and perpetuating the negative equity deficit with the new vehicle.

Insurance, known as “gap” insurance, is available to protect the owner from the financial impact of negative equity in limited circumstances where a purchased or leased vehicle is stolen or totaled in an accident. Gap insurance is purchased by the buyer or lessee at the time the vehicle is purchased or leased and paid for with monthly premiums over the period of the loan or lease. If the vehicle is stolen or totaled during the period of the loan or lease, the insurer pays the difference in the amount owed on the vehicle less the fair market value of the vehicle at the time the vehicle was stolen or totaled, and less any contractual deductible amount.

However, a gap insurance equivalent is not available to cover the difference between the loan amount on a purchased vehicle and its actual value if the vehicle is voluntarily traded before the fair market value of the vehicle exceeds the amount of the outstanding loan. A method to minimize the financial impact of this gap would be of value to the vehicle owner and also to the vehicle dealer, since the owner would be motivated to trade earlier and again with the vehicle dealer.

### SUMMARY OF THE INVENTION

Generally, the objectives of the present invention are achieved through issuance of a policy similar in format to an insurance policy to purchasers of vehicles from a participating dealer or a dealer within a selected group of participating dealers. Generally, the policy provides that the issuer of the policy, referred to herein as the insurer, will pay the difference between the amount owed on the vehicle and the unadjusted fair market value of the vehicle less any deductible amount, if the vehicle is traded after the end of the predetermined time period.

The fair market value of a vehicle is determined by downwardly adjusting the market value of a vehicle for adjustment factors including any excess wear and excess mileage. The amount of these adjustment factors cannot be reasonably estimated at the time the policy is issued. Therefore, the policy will normally provide for payment based on the value of the vehicle before reduction of the vehicle's value by these adjustment factors, i.e., the unadjusted fair market value of the vehicle. The unadjusted fair market value of a vehicle at the time of trade is normally determined by reference to published value guides, such as guides published by NADA, Edmunds or Kelley.

In most instances, the insured vehicle will be an automobile or a truck. However, it should be understood that the term “vehicle” as used herein also includes SUVs, motorcycles, small watercraft, snow mobiles, ATVs, recreational vehicles, etc. The adjustment factors and the manner of determining the unadjusted fair market value of the vehicle may vary depending on the type of vehicle.

To illustrate the invention, a vehicle originally purchased for $25,000, its unadjusted fair market value may be $10,000 at the end of 3 years from the purchase date, before deductions for wear and excess mileage. The amount of the outstanding loan at the end of the 3 years may be as much as $13,792, assuming that the vehicle was financed for 60 months with no down payment. Thus, the negative equity amount of the vehicle would be $3,792, plus any decrease in value due to excess wear and mileage and any other adjustment factors.

If the vehicle is traded at the end of the 3 years, the owner would need to pay this negative equity amount or finance the amount along with the amount financed on the purchase of the new vehicle. However, if the purchaser carried negative equity insurance as described herein, the insurer would pay the dealer this amount, except for loss in value attributable to the adjustment factors, relieving the purchaser from this financial burden.

To obtain negative equity insurance, the purchaser would have purchased negative equity insurance at the time the original vehicle was purchased and would have paid premiums on the insurance from the time of purchase until the time the vehicle was traded after the end of the 3 years. However, the total of the premiums paid would be less than the amount of the amount paid by the insurer, resulting in a net savings to the purchaser. The amount of the premiums may be further reduced if the purchaser elects to pay a deductible amount at the time the vehicle is traded, with the deductible amount being subtracted from the amount to be paid by the insurer.

The insurer is able to cover the difference in the amount paid and the premiums received, plus its overhead expenses and profit margin, due to the fact that many purchasers will not trade their vehicle within a short time after the available trade date. Since the gap decreases as the amount of the loan decreases and the vehicle depreciates at a slower rate, the amount owed by the insurer will decrease, or even be eliminated, as the time between the initial purchase and the end of the predetermined time.

In some policies contemplated by the present invention, a condition of payment may be that the purchaser trades the vehicle with a designated dealer, often the dealer from whom the original vehicle was purchased, or a dealer from among a group of participating dealers. If the purchaser trades the vehicle with other than a designated dealer, if this is a requirement of the agreement, the insurer will not be required to compensate the insured for the negative equity.

The requirement that the purchaser must trade with a designated dealer, i.e., the dealer from whom the original vehicle was purchased or a dealer from among a group of participating dealers, is a powerful motivation for the purchaser to trade with the designated dealer. Depending on the terms of the policy, the amount of the gap at the time of trade can be a few thousand dollars, which would be lost if the purchaser selected a different dealer. In some instances, relief from the financial burden of the gap may be necessary for the purchaser to be able to trade at the desired time.

The motivation of the purchaser to return to a participating dealer instead of trading with a competitor is of considerable value to participating dealers, who will profit from the increased business. In addition, the frequency of trades by regular customers will increase due to the relief from the gap payment. Therefore, the insurer can also reduce the gap insurance rate to purchasers and/or increase profitability by charging a fee to vehicle dealers for the right to be included as a participating dealer.

The basic structure of the negative insurance policy can be modified or embellished to increase market demand. For example, the policy can provide that at least a part of premiums paid will be refunded to the buyer if the buyer cancels the policy before the end of the predetermined time. The policy can also provide that a portion of the negative equity will be paid on a prorated basis if the purchaser desires to trade the vehicle before the end of the predetermined time.

### DETAILED DESCRIPTION OF THE INVENTION

The following examples illustrate the invention:

### Example 1

Buyer A purchases a $25,000 automobile from Dealer B with a down payment of $1,000 and balance of $24,000 financed over a period of 60 months. At the time of purchase Buyer A also purchases a Negative Equity Insurance policy which provides that the insurer will pay Dealer B the difference between the outstanding loan and trade-in value of the automobile at any time after 36 months from the date of purchase, if Buyer A trades the automobile with Dealer B. Trade-in value is defined as the book value of the automobile at the time of trade less any deductions for excess wear or excess mileage.

After 36 months, Buyer A decides that it is time to trade the automobile and returns to Dealer B. All premiums on the Negative Insurance Policy have been paid. At the time Buyer A returns to Dealer B, the outstanding loan on the automobile is $13,420 and the unadjusted fair market value of the automobile is $10,000. Buyer A has taken good care of the automobile and the mileage is not excessive. Therefore, when Buyer A buys a new automobile from Dealer B at an agreed purchase price, the insurer pays $3,240, the difference between the outstanding loan amount and the unadjusted fair market value. This payment and the value of the automobile is used to pay off the loan on the original automobile, enabling Buyer A to acquire the new automobile without the need to pay any gap or negative equity amount.

Thus, assuming Buyer A pays a total premium of $995 for the Negative Equity Insurance policy, a net savings of $2,245 is realized. Dealer B profits from the new trade with the returning buyer. Since some buyers will not trade within a short period after the designated term, or will choose to trade with another dealer, the insurer will profit due to the fact that total premiums from all insured buyers will exceed the total amount paid to the individuals who do avail themselves of the policy provisions. In addition, the insurer may also profit from any fees charged to participating dealers.

### Example 2

The present invention is also applicable to participation of multiple dealers in a group, enabling a buyer who has purchased a vehicle from one participating dealer to trade the vehicle with another participating dealer without loosing the coverage of the negative equity insurance. For example, a buyer who purchases a vehicle from a participating dealer in one geographical area, e.g., one city, and then moves to another city would be able to trade the vehicle with a participating dealer near his new home.

To illustrate, Buyer C purchases an automobile from participating Dealer D in City F for $25,000 with a 10%, i.e., $2,500 down payment and finances the balance over 60 months. Buyer C also purchases negative equity insurance for $995 for a term of 5 years, which provides that if Buyer C trades the automobile with any participating dealer after the end of 3 years, the insurer will pay the difference between the outstanding loan balance and the unadjusted fair market value of the automobile at any time after the term. Unadjusted fair market value is defined as the book value of the automobile at the time of trade less any deductions for excess wear or excess mileage.

At the end of the 3 years, Buyer D goes to participating Dealer G in city H. All premiums on the Negative Insurance Policy have been paid. The outstanding loan on the automobile is $12,413 and the book value of the automobile determined from the NADA Black Book or other published value guides is $10,000. However, the fair market value of the automobile is $1,000 less than the book value due to excess mileage. Therefore, when Buyer D buys a new automobile from Dealer G at an agreed purchase price, the insurer pays $1,413, the difference between the outstanding loan amount and the book value, less the $1,000 for excess mileage. This payment and the value of the automobile is used to pay off the loan on the original automobile, enabling Buyer D to acquire the new automobile by paying or financing only the $1,000 due to the excess mileage. Thus, Buyer D has paid a total premium of $995 for the Negative Equity Insurance policy, thereby receiving a net savings of $413.

If the purchaser has elected to pay a deductible amount at the time the policy was purchased in either of the above examples in order to reduce the premiums, the deductible amount would also be subtracted from the amount paid by the insurer.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method for compensating a vehicle buyer for negative equity in a vehicle purchased from a vehicle dealer and traded at a predetermined time after purchase of the vehicle comprising:
a) issuing a premium bearing policy to a purchaser of a vehicle from a given vehicle dealer, said policy providing that the purchaser is to pay premiums; and
b) paying on behalf of the buyer a compensated value equal to the amount owed on the vehicle less deductions and less the unadjusted fair market value of the vehicle at the time the vehicle is traded with the vehicle dealer, provided that all premiums have been paid.

2. The method of claim 1, wherein said vehicle is financed over a given period of time and said predetermined time is from 50% to 100% of said given time.

3. The method of claim 1, wherein said vehicle is selected from the group consisting of automobiles, trucks, SUVs, motorcycles, small watercraft, snow mobiles, ATVs, and recreational vehicles.

4. The method of claim 1, wherein said policy provides for monthly payment amounts included with the buyers vehicle payments.

5. The method of claim 1, wherein the dealer pays an amount to the insurer in consideration of issuance of the policy.

6. The method of claim 1, wherein the negative equity at the time of trade is from about 50% to about 500% of the premiums paid.

7. The method of claim 1, wherein said fair market value is determined using published value guides.

8. The method of claim 1, wherein the buyer has a right to cancel the policy prior to the end of the predetermined period and obtain a reimbursement of at least part of premiums paid.

9. A method for compensating a vehicle buyer for negative equity in a vehicle purchased from a vehicle dealer within a group of participating vehicle dealers and traded at a predetermined time after purchase of the vehicle comprising:
a) issuing a premium bearing policy to a purchaser of a vehicle from a given vehicle dealer, said policy providing that the purchaser is to pay premiums; and
b) paying on behalf of the buyer a compensated value equal to the amount owed on the vehicle less deductions and less the unadjusted fair market value of the vehicle at the time the vehicle is traded with a vehicle dealer within a group of participating vehicle dealers, provided that all premiums have been paid.

10. The method of claim 9, wherein said vehicle is financed over a given period of time and said predetermined time is from 50% to 100% of said given time.

11. The method of claim 9, wherein said vehicle is selected from the group consisting of automobiles, trucks, SUVs, motorcycles, small watercraft, snow mobiles, ATVs, and recreational vehicles.

12. The method of claim 9, wherein said policy provides for monthly payment amounts included with the buyers vehicle payments.

13. The method of claim 9, wherein the dealer pays an amount to the insurer in consideration of issuance of the policy.

14. The method of claim 9, wherein the negative equity at the time of trade is from about 50% to about 500% of the premiums paid.

15. The method of claim 9, wherein said fair market value is determined using published value guides.

16. The method of claim 9, wherein the buyer has a right to cancel the policy prior to the end of the predetermined period and obtain a reimbursement of at least part of premiums paid.

17. The method of claim 9, wherein the vehicle dealer within the group of participating vehicle dealers are in different geographical locations.

18. The method of claim 9, wherein said policy provides that the insurer will pay a prorated amount of the policy if the purchaser trades the vehicle prior to the end of the predetermined time.
